(19) United States
(12) Patent Application Publication
(10) Pub. No.: US 2026/0134352 A1
(43) Pub. Date: May 14, 2026

(54) REAL-TIME CLINICAL AI DRIFT DETECTION AND REGULATORY EVIDENCE GENERATION SYSTEM

(71) Applicant: George William Bickerstaff, III, Greenwich, CT (US)

(72) Inventor: George William Bickerstaff, III, Greenwich, CT (US)

(21) Appl. No.: 19/445,097

(22) Filed: Jan. 9, 2026

(51) Int. Cl. G06N 20/00

(52) U.S. Cl. CPC G06N 20/00

(57) ABSTRACT

A real-time clinical AI drift detection and regulatory evidence generation system continuously monitors AI-assisted clinical workflows for deviation from validated, regulator-aligned baselines. The system classifies regulatory relevance and produces auditable post-market surveillance evidence while preserving clinician authority. Continuous regulatory readiness is achieved without autonomously diagnosing conditions or prescribing treatment actions.

### TECHNICAL FIELD

The present disclosure relates to regulated healthcare information systems and, more particularly, to computer-implemented systems and methods for continuous, real-time detection of performance drift in artificial intelligence-assisted clinical workflows and automated generation of regulator-aligned post-market surveillance evidence supporting lifecycle compliance, auditability, and risk governance.

### BACKGROUND

Artificial intelligence systems deployed in clinical environments are typically validated against defined performance baselines prior to deployment. However, real-world performance may change over time due to shifts in patient populations, data distributions, clinical protocols, operational workflows, or environmental conditions.

Such performance drift may introduce safety, compliance, or liability risks if not detected, contextualized, and documented in a timely and defensible manner.

Regulatory authorities increasingly expect continuous post-market surveillance and lifecycle monitoring demonstrating that AI-assisted clinical systems remain within validated performance bounds following deployment.

Existing approaches to drift detection are often retrospective, offline, model-centric, or disconnected from clinical workflows and regulatory documentation requirements, limiting their usefulness for real-time governance and regulatory inspection.

Accordingly, there exists a need for a technical system that continuously monitors AI-assisted clinical workflows, detects clinically and regulatorily meaningful drift events, correlates such drift with operational context and AI versioning, and generates immutable, regulator-aligned evidence artifacts without autonomously diagnosing medical conditions or directing treatment actions.

### SUMMARY

The disclosed invention provides a computer-implemented real-time clinical AI drift detection and regulatory evidence generation system that continuously monitors AI-assisted clinical workflows relative to validated, regulator-aligned performance baselines.

The system detects statistically and operationally significant drift events, classifies regulatory relevance, correlates drift with workflow context and AI versioning, and generates structured, auditable post-market evidence artifacts suitable for regulatory inspection, audit, and defense.

The system operates independently of clinical decision authority, preserves clinician control, and provides a technical infrastructure for continuous regulatory readiness and defensible lifecycle governance of clinical AI systems.

### Definitions

Baseline Performance Profile means a validated, regulator-aligned representation of expected AI system behavior.

Drift Event means a deviation from a baseline performance profile exceeding defined statistical or operational thresholds.

Drift Metric means a quantitative measure evaluating stability of AI outputs over time, including at least one of distributional shift, confidence variance, or outcome divergence.

Monitoring Horizon means a defined temporal window over which drift metrics are evaluated.

Post-Market Evidence Artifact means a structured dataset or document prepared for regulatory or audit review.

Regulatory Classification means a categorization of drift events by compliance relevance.

Statistical Threshold means a predefined boundary indicating significant deviation from expected performance.

Surveillance Policy means a rule governing monitoring frequency, sensitivity, and escalation behavior.

Validation Baseline means an approved performance state derived from pre-deployment validation activities.

Workflow Drift Engine means a software component configured to detect, classify, and record AI performance drift.

### BRIEF DESCRIPTION OF THE DRAWINGS

FIG. 1—REAL-TIME CLINICAL AI DRIFT DETECTION SYSTEM OVERVIEW illustrates an overall system architecture for monitoring AI-assisted clinical workflows, detecting performance drift, classifying regulatory relevance, and generating post-market evidence.

FIG. 2—BASELINE CONFIGURATION AND SURVEILLANCE SETUP illustrates configuration of validated baseline performance profiles, drift metrics, statistical thresholds, monitoring horizons, and surveillance policies.

FIG. 3—DRIFT DETECTION AND GOVERNANCE ESCALATION FLOW illustrates detection of performance deviations, aggregation of drift signals, regulatory significance classification, escalation workflows, and resolution tracking.

FIG. 4—REGULATORY EVIDENCE GENERATION AND SUBMISSION READINESS illustrates compilation of drift evidence datasets, generation of technical summaries, regulatory formatting, readiness assessment, and secure export.

FIG. 5—AUDIT LOGGING AND LIFECYCLE OVERSIGHT illustrates audit logging, AI model lifecycle timelines, oversight dashboards, access controls, archival, and document export.

### DETAILED DESCRIPTION

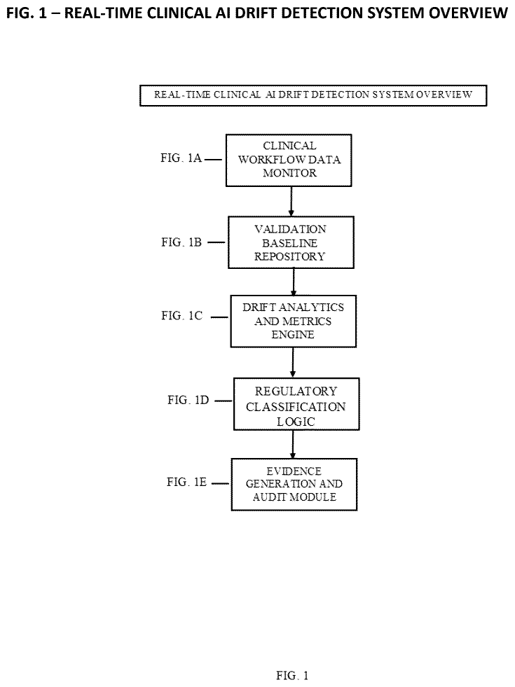

### FIG. 1—Real-Time Clinical AI Drift Detection System Overview

FIG. 1—REAL-TIME CLINICAL AI DRIFT DETECTION SYSTEM OVERVIEW illustrates a real-time clinical AI drift detection system comprising workflow monitors, baseline repositories, drift analytics engines, regulatory classification logic, evidence generation modules, and audit infrastructure. The system operates continuously alongside AI-assisted clinical workflows without influencing diagnostic or treatment decisions. Deployment may occur within regulated healthcare information technology environments.

FIG. 1A—CLINICAL WORKFLOW DATA MONITOR illustrates a module configured to passively capture AI outputs, confidence metrics, contextual metadata, and workflow state information in real time. Monitoring does not modify workflow execution. All captured data are time-stamped and version-linked.

FIG. 1B—VALIDATION BASELINE REPOSITORY illustrates storage of validated, regulator-aligned baseline performance profiles associated with specific AI versions and deployment contexts. Baselines are version-controlled and auditable. Baseline access events are logged.

FIG. 1C—DRIFT ANALYTICS AND METRICS ENGINE illustrates computation of drift metrics relative to baseline profiles using predefined statistical methods. Drift metrics may include distributional shift, confidence variance, or outcome divergence. Computation results are immutably recorded.

FIG. 1D—REGULATORY CLASSIFICATION LOGIC illustrates assignment of compliance relevance to detected drift events based on policy-defined rules. The logic distinguishes benign variation from reportable drift. Classification criteria are configurable by jurisdiction.

FIG. 1E—EVIDENCE GENERATION AND AUDIT MODULE illustrates generation of immutable post-market surveillance artifacts aligned with regulatory expectations. Artifacts include drift metrics, contextual metadata, and timestamps. All artifact generation actions are logged.

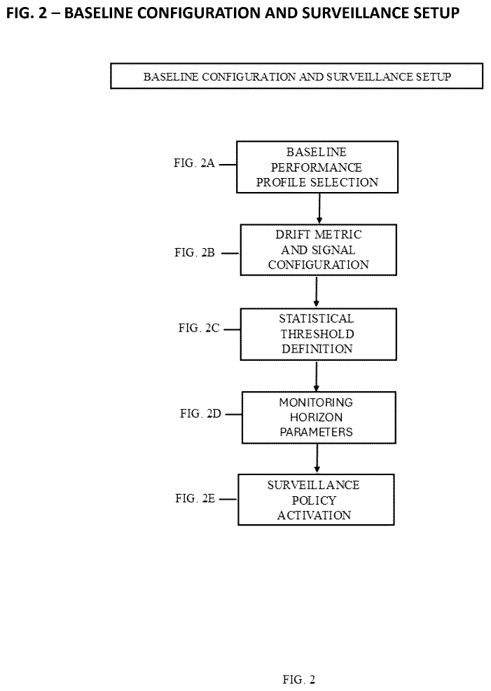

### FIG. 2—Baseline Configuration and Surveillance Setup

FIG. 2—BASELINE CONFIGURATION AND SURVEILLANCE SETUP illustrates configuration of validation baselines and surveillance policies ensuring monitoring behavior aligns with regulatory requirements. Configuration actions are auditable. Changes are versioned.

FIG. 2A—BASELINE PERFORMANCE PROFILE SELECTION illustrates selection of validation baseline profiles derived from approved pre-deployment studies. Selected baselines are linked to specific AI versions. Selection decisions are recorded.

FIG. 2B—DRIFT METRIC AND SIGNAL CONFIGURATION illustrates configuration of drift metrics relevant to clinical and regulatory risk. Metrics may vary by workflow. Configuration parameters are version-controlled.

FIG. 2C—STATISTICAL THRESHOLD DEFINITION illustrates definition of statistical thresholds used to determine drift significance. Threshold definitions are preserved for audit. Threshold changes are logged.

FIG. 2D—MONITORING HORIZON PARAMETERS illustrates configuration of temporal windows over which drift metrics are evaluated. Horizons may vary by risk profile. Horizon changes are recorded.

FIG. 2E—SURVEILLANCE POLICY ACTIVATION illustrates activation of surveillance policies governing monitoring frequency, sensitivity, and escalation behavior. Activation initiates continuous monitoring. Policy changes are tracked.

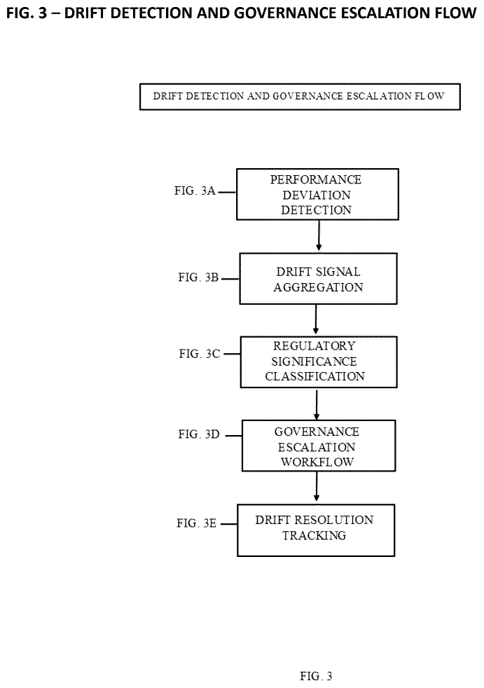

### FIG. 3—Drift Detection and Governance Escalation Flow

FIG. 3—DRIFT DETECTION AND GOVERNANCE ESCALATION FLOW illustrates detection, classification, escalation, and resolution of drift events during live operation. Detection is continuous and non-disruptive. Escalation supports governance oversight.

FIG. 3A—PERFORMANCE DEVIATION DETECTION illustrates identification of metric deviations exceeding configured thresholds. Deviations are quantified and contextualized. Detection events are logged.

FIG. 3B—DRIFT SIGNAL AGGREGATION illustrates aggregation of drift signals across time, workflows, or AI versions. Aggregation improves robustness. Aggregated signals preserve lineage.

FIG. 3C—REGULATORY SIGNIFICANCE CLASSIFICATION illustrates assignment of regulatory classifications distinguishing minor variation from reportable drift. Classification rationale is documented. Classification results inform escalation.

FIG. 3D—GOVERNANCE ESCALATION WORKFLOW illustrates escalation of regulator-relevant drift events to designated governance roles. Escalation follows predefined workflows. Escalation actions are logged.

FIG. 3E—DRIFT RESOLUTION TRACKING illustrates tracking of remediation or mitigation actions associated with drift events. Status updates are versioned. Tracking supports lifecycle compliance.

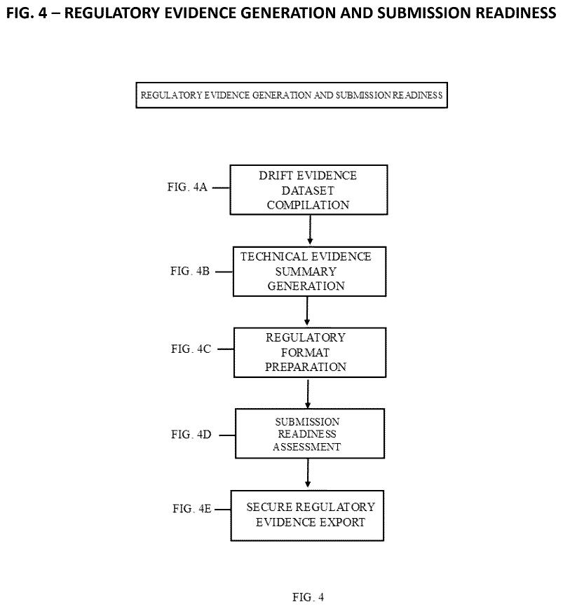

### FIG. 4—Regulatory Evidence Generation and Submission Readiness

FIG. 4—REGULATORY EVIDENCE GENERATION AND SUBMISSION READINESS illustrates generation of regulator-aligned post-market evidence artifacts. Artifacts are structured and immutable. Generation is deterministic.

FIG. 4A—DRIFT EVIDENCE DATASET COMPILATION illustrates compilation of drift metrics, baseline references, and contextual metadata into structured datasets. Compilation preserves original data. Datasets are versioned.

FIG. 4B—TECHNICAL EVIDENCE SUMMARY GENERATION illustrates generation of technical narrative summaries contextualizing detected drift. Summaries explain metrics and context. Clinical decision content is excluded.

FIG. 4C—REGULATORY FORMAT PREPARATION illustrates formatting of evidence artifacts to align with regulatory submission standards. Formatting actions are logged. Format configurations are retained.

FIG. 4D—SUBMISSION READINESS ASSESSMENT illustrates automated evaluation of regulatory submission readiness. Readiness indicators are generated. Assessments are auditable.

FIG. 4E—SECURE REGULATORY EVIDENCE EXPORT illustrates secure export of regulatory evidence artifacts. Export preserves integrity and chain of custody. Patient identifiers are excluded.

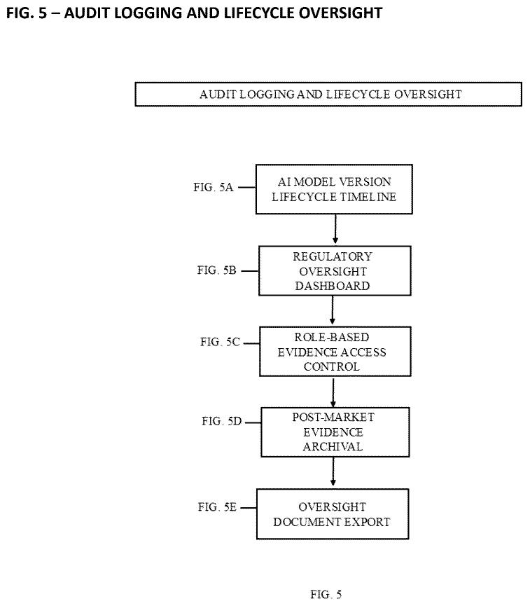

### FIG. 5—Audit Logging and Lifecycle Oversight

FIG. 5—AUDIT LOGGING AND LIFECYCLE OVERSIGHT illustrates audit logging and lifecycle tracking associated with drift governance. Logs capture monitoring, detection, classification, and reporting events. Oversight is continuous.

FIG. 5A—AI MODEL VERSION LIFECYCLE TIMELINE illustrates lifecycle timelines linking drift events to AI model versions and deployments. Timelines preserve historical context. Timelines are immutable.

FIG. 5B—REGULATORY OVERSIGHT DASHBOARD illustrates dashboards summarizing drift trends and regulatory classifications. Dashboards are read-only. Dashboards support oversight.

FIG. 5C—ROLE-BASED EVIDENCE ACCESS CONTROL illustrates access controls governing regulatory evidence. Access events are logged. Controls enforce separation of roles.

FIG. 5D—PST-MARKET EVIDENCE ARCHIVAL illustrates archival of evidence artifacts according to retention policies. Artifacts remain retrievable. Archival supports audits.

FIG. 5E—OVERSIGHT DOCUMENT EXPORT illustrates export of oversight documentation for external review. Export preserves integrity. Export supports inspection.

### EXAMPLE

In one example, an AI-assisted stroke detection system is deployed following regulatory clearance and monitored continuously using a validated baseline sensitivity profile.

The system detects a statistically significant deviation over a defined monitoring horizon and classifies the event as regulator-relevant drift. A post-market evidence artifact is generated and escalated for governance review.

The artifact is archived for inspection, and the system does not autonomously diagnose conditions or prescribe treatment actions.

1. A computer-implemented system, comprising:
one or more processors; and
a non-transitory computer-readable memory storing instructions that, when executed, cause the system to:
monitor AI-assisted clinical workflows;
detect performance drift relative to validated, regulator-aligned baselines;
classify regulatory relevance of detected drift events;
correlate drift with workflow context and AI versioning; and
generate auditable post-market evidence artifacts,
wherein the system does not autonomously diagnose a medical condition or prescribe a treatment action.

2. A computer-implemented method, comprising:
establishing validated, regulator-aligned baselines;
continuously monitoring AI-assisted clinical workflows;
detecting drift events;
classifying regulatory significance;
correlating drift with deployment context; and
generating regulator-ready post-market evidence artifacts.

3. A non-transitory computer-readable medium storing instructions that cause one or more processors to perform the method of claim 2.

4. The system of claim 1, wherein drift metrics include distributional shift or confidence variance.

5. The system of claim 1, wherein regulatory classifications are policy-driven.

6. The system of claim 1, wherein evidence artifacts are immutable.

7. The system of claim 1, wherein escalation requires human governance review.

8. The system of claim 1, wherein baselines are derived from pre-deployment validation.

9. The method of claim 2, wherein monitoring horizons are configurable.

10. The system of claim 1, wherein audit logs preserve chain of custody.
